(19) United States
(12) Patent Application Publication
(10) Pub. No.: US 2005/0124351 A1
(43) Pub. Date: Jun. 9, 2005

(54) Method and apparatus for establishing direct mobile to mobile communication between cellular mobile terminals

(76) Inventors: Greg R. Black, Vernon Hills, IL (US); Charles P. Binzel, Bristol, WI (US); George W. Meyer, Mundelein, IL (US)

Correspondence Address: MOTOROLA INC, 600 NORTH US HIGHWAY 45, ROOM AS437, LIBERTYVILLE, IL, 60048-5343, US

(21) Appl. No.: 10/614,231

(22) Filed: Dec. 3, 2003

(51) Int. Cl. H04Q 7/20

(52) U.S. Cl. 455/452.2; 455/423; 455/67.11

(57) ABSTRACT

The present invention provides a method for establishing direct mobile to mobile communication between cellular mobile terminals. The method includes selecting a frequency designated as a mobile communication frequency within a cellular communication system, and transmitting a communication initiation sequence at the selected frequency by a first mobile terminal. A second mobile terminal then monitors the designated mobile communication frequencies, and detects the communication initiation sequence. In at least one embodiment, selecting a frequency includes determining the region in which the first mobile terminal is operating, and selecting a mobile communication frequency for the determined region. In at least a further embodiment, the mobile communication frequency is a mobile transmission frequency for the determined region. In at least a still further embodiment, selecting a frequency includes selecting a frequency that is designated as a mobile transmit frequency in a first supported region and is designated as a mobile receive frequency in a second supported region.

### FIELD OF THE INVENTION

The present invention relates generally to establishing direct mobile to mobile communication between cellular mobile terminals and, more particularly, establishing communication using at least one of one or more frequencies pre-designated as a mobile communication frequency within a cellular communication system.

### BACKGROUND OF THE INVENTION

Cellular communication systems generally rely upon an installed infrastructure in order to process and manage calls. In most cellular systems, calls made between two mobile cellular terminals are generally routed through one or more respective base stations that provide service to the areas in which the mobile terminals are located. However, because network coverage does not exist in all areas, a mobile cellular terminal can sometimes be outside of the network coverage areas. In these instances, communication through the system is not possible.

Often times, an operator will own the usage rights for a relevant portion of the cellular operating spectrum in geographical areas that extend beyond the existing installed coverage areas. The decision to install the infrastructure to support coverage for an area is largely based upon a determination that there is sufficient present usage demand or anticipated future usage demand in an area to offset the costs of installing and maintaining the necessary network equipment. In some instances, an operator may elect to only implement a limited deployment that provides coverage for a reduced number of users, in which less than all of the available channels and/or spectrum are utilized.

For a mobile subscriber, geographical areas which do not have network coverage can be very frustrating, especially when the subscriber enters or is in one of the areas that does not have coverage and the subscriber wishes to maintain or establish a call connection. In absence of supporting infrastructure, generally one can not establish or maintain a call connection, in absence of some alternatively supported method of communication. However there may be instances, when the ability to make a call in areas, which do not presently have coverage could be very useful. Consequently, it would be beneficial to provide alternative methods of communication between users, including methods which support communication in geographical areas where supporting infrastructure equipment has not yet been installed. It would be further beneficial to develop methods, which can be supported by existing mobile handset designs without requiring significant hardware modifications.

### SUMMARY OF THE INVENTION

The present invention provides a method for establishing direct mobile to mobile communication between cellular mobile terminals. The method includes selecting a frequency designated as a mobile communication frequency within a cellular communication system, and transmitting a communication initiation sequence at the selected frequency by a first mobile terminal. A second mobile terminal then monitors the designated mobile communication frequencies, and detects the communication initiation sequence.

In at least one embodiment, selecting a frequency includes determining the region in which the first mobile terminal is operating, and selecting a mobile communication frequency for the determined region.

In at least a further embodiment, the mobile communication frequency is a mobile transmission frequency for the determined region.

In at least a still further embodiment, selecting a frequency includes selecting a frequency that is designated as a mobile transmit frequency in a first supported region and is designated as a mobile receive frequency in a second supported region.

The present invention further provides a cellular mobile terminal adapted for direct mobile to mobile communication. The mobile terminal includes a transmitter, a receiver, and a control circuit, which is coupled to the transmitter and the receiver. At least one of the transmitter and the receiver is adapted to function at a frequency of operation, that corresponds to the other one of the transmitter and the receiver.

These and other features, and advantages of this invention are evident from the following description of one or more exemplary embodiments of this invention, with reference to the accompanying drawings.

### BRIEF DESCRIPTION OF THE DRAWINGS

FIG. 1 is a diagram of at least the wireless communication portion of an exemplary wireless communication system including illustrated communications between a base station and mobile subscriber and direct communication between different mobile subscribers, in accordance with the present invention;

FIG. 2 is a flow diagram of a method for establishing direct mobile to mobile communication between cellular mobile terminals, in accordance with at least one embodiment of the present invention;

FIG. 3 is a table illustrating the defined frequency ranges for a couple of related exemplary cellular communication systems operating in different geographical regions;

FIG. 4 is a block diagram of a wireless communication device within which the present invention can be incorporated; and

FIG. 5 is a more detailed block diagram of the RF interface and processing control portions of the wireless communication device illustrated in FIG. 4.

### DETAILED DESCRIPTION OF THE PREFERRED EMBODIMENT(S)

While the present invention is susceptible of embodiment in various forms, there is shown in the drawings and will hereinafter be described presently preferred embodiments with the understanding that the present disclosure is to be considered an exemplification of the invention and is not intended to limit the invention to the specific embodiments illustrated.

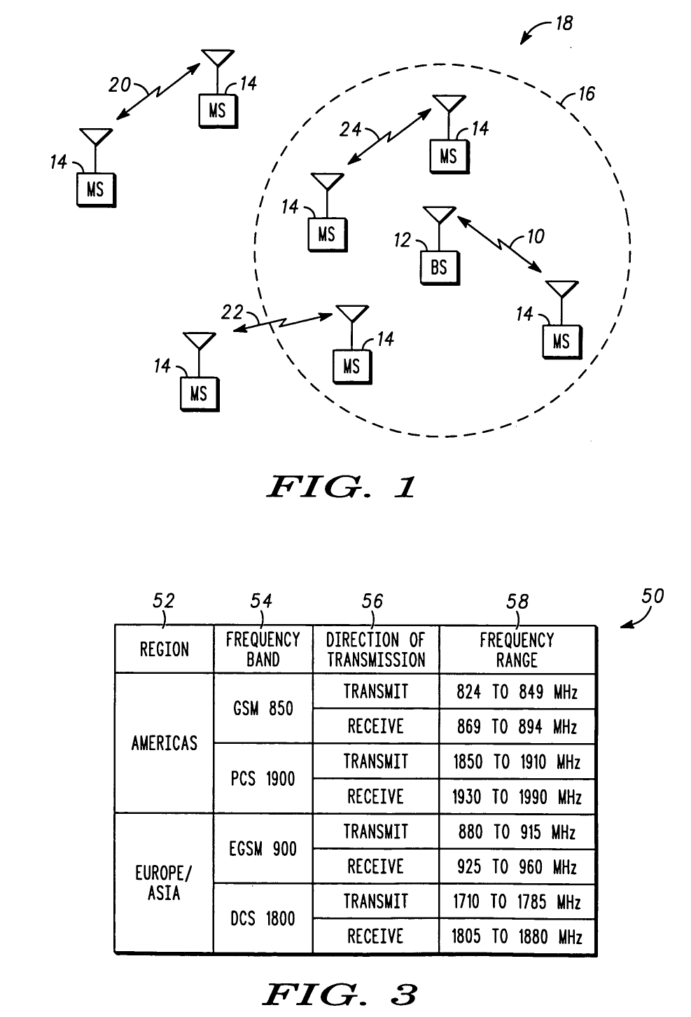

FIG. 1 illustrates an example of a communication 10 between a base station 12 and a mobile subscriber 14, and several examples of direct communication between two mobile subscribers 14, relative to an area of coverage 16 within a region 18, which supports at least some cellular communication within a cellular network. The diagram illustrates direct communication between at least three pairs of mobile subscribers 14, each pair having a different relationship relative to the supported coverage area 16. At least three different possibilities exist defining the location of one or both of the directly communicating mobile subscribers 14 relative to an existing coverage area 16.

A first pair of mobile subscribers 14 illustrates direct communication 20 between mobile subscribers 14, which are each outside of the supported coverage area 16. A second pair illustrates direct communication 22 between mobile subscribers 14, where a first one of the mobile subscribers 14 is within the supported coverage area 16 and a second one of the mobile subscriber 14 is outside of the supported coverage area 16. Lastly, a third pair illustrates direct communication 24 between mobile subscribers 14, where both mobile subscribers 14 are within the supported coverage area 16. Each of the three possible positional relationships of the mobile subscribers 14 relative to the coverage area 16, can present different concerns or require different considerations, while establishing or maintaining a direct mobile to mobile communication using a frequency designated as a mobile communication frequency within a cellular communication system.

For example any direct communication between mobile cellular subscribers 14, where at least one of the mobile subscribers 14 is located within the operational range of a base station 12, would need to operate and behave in a manner which does not interfere with any authorized communication between a mobile subscriber 14 and the base station 12. Furthermore, a mobile subscriber 14 needs to be aware of its changing relationship relative to areas 16 of network coverage, so as to be able to detect when it is entering or exiting an area 16 of network coverage, and change its behavior accordingly.

In at least one embodiment, generally, any communication involving a mobile subscriber 14 located within an area 16 of coverage of a cellular communication system and a frequency designated for use by the cellular communication system, would need to obtain some form of authorization from the network. A mobile subscriber 14 located in or entering an area 16 of coverage and wishing to initiate or maintain direct mobile to mobile communication might need to contact the supporting base station 12 at the proximate time that the communication is going to occur for receipt of express authorization, which might also include a temporary frequency and/or channel assignment. In some instances, upon entering an area of coverage, direct mobile to mobile communication may need to terminate, as the network may elect not to assign a frequency and/or channel or may not have available a frequency and/or channel for use in supporting continued mobile to mobile communication.

Where both mobile subscribers 14 are outside of the existing coverage areas 16, the situation may be a little less formal, and may only require a general authorization from the party that owns the licensed spectrum to make use of the spectrum in non-coverage areas. Where there is no direct overlap between the area of coverage and the area through which the communication will likely travel, the mobile subscriber 14 initiating the communication may have greater flexibility and/or freedom in selecting a specific frequency and/or a communication channel for supporting a subsequent non-network supported communication.

In at least one embodiment, the method of direct communication between mobile subscribers is similar to the nature of communication that occurs within the network between a mobile subscriber and a base station. Some changes may be necessary, however, to accommodate the performance of any functions necessary for establishing or maintaining communication, that are traditionally performed by the base station.

FIG. 2 illustrates a flow diagram 30 of a method for establishing direct mobile to mobile communication between cellular mobile terminals, in accordance with at least one embodiment of the present invention. More specifically, the method provides for selecting 32 a frequency designated as a mobile communication frequency, which may or may not be in response to receiving 34 an actuation from a user that is indicative of a desire to establish a direct mobile to mobile communication. A communication initiation sequence is then transmitted 36 by a first mobile unit at the selected frequency.

A second mobile unit or terminal then detects 38 the initiation sequence after monitoring 40 the designated mobile communication frequencies. The second mobile unit may then transmit 42 an acknowledgement signal to the first mobile unit, in response to the detection 38 of the initiation sequence. In at least one embodiment the acknowledgement signal can be transmitted at the same frequency used by the first mobile unit to transmit 36 the initiation sequence. Alternatively, a second frequency could be used. However, if a second frequency is used, it may be necessary for the first mobile unit to similarly monitor the available frequencies in order to identify the response frequency. Furthermore, it is possible that a second paired frequency could be designated, based upon the first frequency selected 32. Still further the acknowledgement signal could be used to provide received signal quality data to the first mobile station, which can be used to adjust the quality of subsequently transmitted signals. In at least one instance, the received signal quality data provides receiver level information (i.e. received signal strength), which can be used to adjust the gain of any subsequently transmitted signals.

By enabling the first mobile unit to select a frequency and the second mobile unit to then monitor for transmission over the designated mobile frequencies, there is no need for the mobile units to prearrange a particular frequency over which communication will occur. This will allow a first mobile unit to dynamically select a frequency, which can take into account environmental conditions at the time that the communication between mobiles will occur including conditions that may be difficult to predict ahead of time. For example, another pair of mobiles may already be using a particular frequency. Furthermore, other sources of noise could be present in a particular area. Still further, at least one of the mobiles might be present within an area for which network coverage exists, and therefore the mobiles may need to transmit using a frequency/channel assigned by the network.

In at least one embodiment, the duration of transmission of the initiation sequence by the originating first mobile communication unit is managed, so as to be of a sufficient duration to accommodate power saving sleep periods during which the second mobile communication unit is not actively searching for a communication signal from another mobile communication unit. Generally, this can require that the duration of the transmission of the originating first mobile communication unit to be sufficiently long to insure at least some overlap with the period of time that the second mobile communication unit is awake and monitoring for transmissions. A power saving sleep period refers to interspersed periods of time during which portions of the mobile communication unit is disabled to conserve power consumption. Generally the sleep periods are periodic in frequency and duration. During sleep periods, the ability of the mobile communication unit to receive a signal can often be affected.

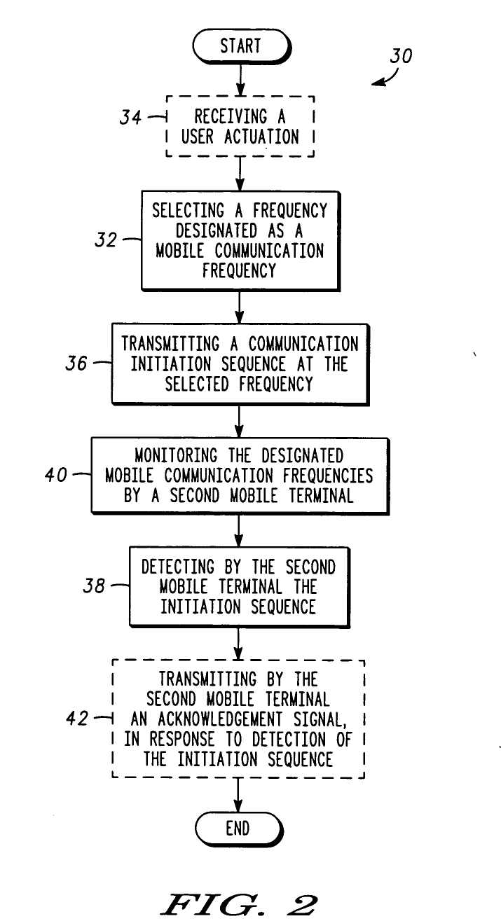

FIG. 3 is a table illustrating the defined frequency ranges for a couple of related exemplary cellular communication systems operating in different geographical regions. More specifically, the table relates to assigned frequencies in Europe/Asia and the Americas for a Global System for Mobile Communications (GSM)-type cellular radio telephone system. The table includes separate entries for different regions 52, different frequency bands 54 within a region, and the direction of transmission 56 for the mobile stations 14 operating in a particular frequency band within a given region. For each entry, a predefined frequency range 58 is provided. More specifically, the table illustrates the frequency ranges 58 for transmit and receive for four different frequency bands 54, two of which generally correspond to the Americas and two of which generally correspond to Europe/Asia.

By using predesignated frequencies relative to a cellular communication system, hand sets, which support the existing cellular communication standard can be used to provide mobile to mobile communication with no more than minimal modifications, if any, to the transmitter and the receiver portions of the mobile subscriber unit. Furthermore, when the user is in an area supported by network coverage, the same device can be readily used to access the cellular communication system via the supporting infrastructure.

In at least some embodiments, the frequency usage range is defined even more narrowly, so as to limit communication to using a frequency, which corresponds to both a valid transmission and reception frequency within at least one of the supported frequency bands of a given device. For example, there exists tri-band and quad-band phones, which correspondingly support communication in three and four of the four pre-designated bands, respectively. Tri-band and quad-band phones are sometimes alternatively referred to as world phones.

Between the four bands, frequency overlap, which supports both transmission and reception exists for frequency ranges 880-894 MHz and 1850-1880 MHz. More specifically, the frequency range 880-894 MHz is supported for transmission in frequency band EGSM 900, and is supported for reception in frequency band GSM 850, in mobile communication units that support both EGSM 900 and GSM 850 frequency bands. The frequency range 1850-1880 MHz is supported for transmission in frequency band PCS 1900, and is supported for reception in frequency band DCS 1800, in mobile communication units that support both PCS 1900 and DCS 1800 frequency bands.

In yet a still further embodiment, the particular frequency range selected for use in a mobile to mobile communication may correspond to the frequency overlap range, which supports mobile transmissions from the mobile subscriber to the base station in the region in which the mobile subscriber units are presently operating. This will limit the possible interference to other mobile subscribers from mobile to mobile transmissions that may occur in their relative proximity. The mobiles within a given region are generally already designed to tolerate nearby noise from other mobile subscriber sources operating in these frequencies, such that a mobile to mobile communication using the same frequency would not be as potentially disruptive to the operation of other nearby mobiles. In Europe and Asia this frequency range corresponds to 880-894 MHz. In the Americas this frequency range corresponds to 1850-1880 MHz.

As a result, it may be beneficial for the mobile subscriber wishing to engage in a mobile to mobile communication to be able to determine the region in which it is operating. In some instances, the region in which the phone is operating can be determined by monitoring existing communications within a nearby area of network coverage. However, in instances where a mobile subscriber is operating sufficiently outside of existing areas of coverage, such that there are no detectable existing communications to monitor, the subscriber unit may make a regional determination based upon the most recent determination of the operating region during which existing communications were available to monitor. Alternatively, the mobile subscriber unit could allow the user to manually select the appropriate region.

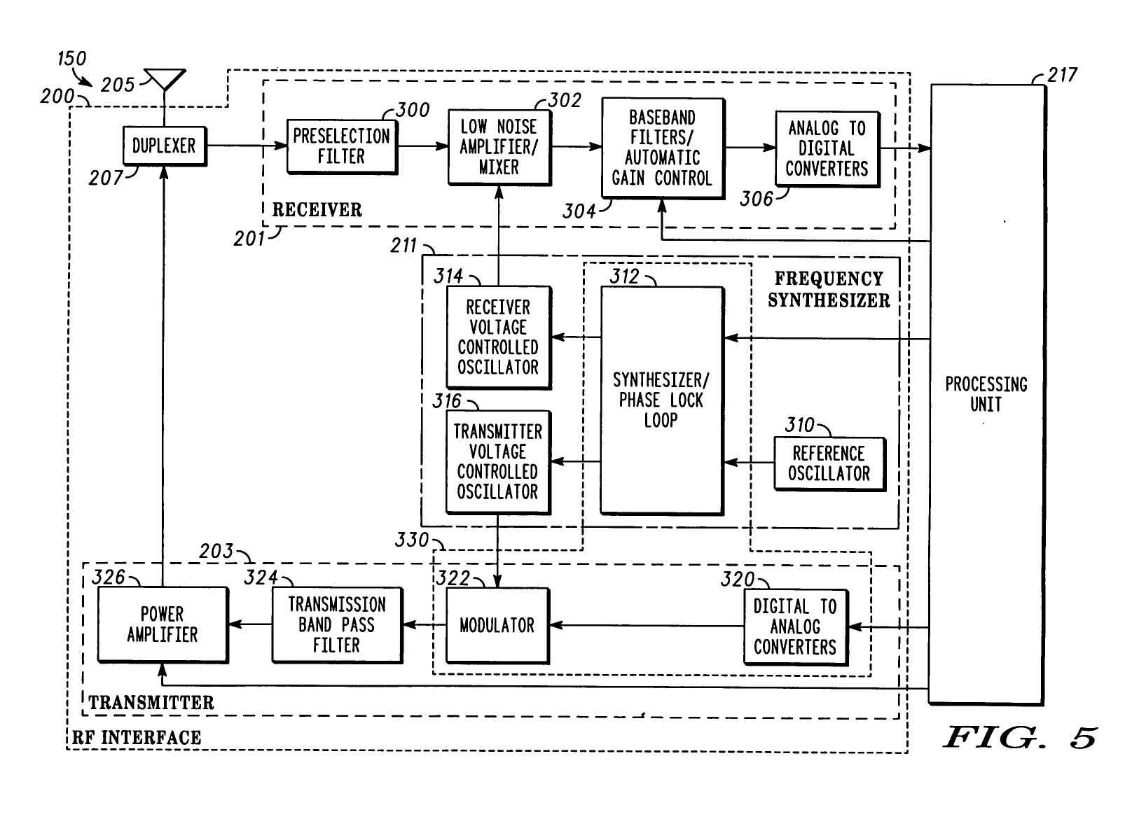

While the above example illustrates one possible set of frequencies for use in mobile to mobile communication, that can be readily implemented without requiring the significant expansion of the communication capabilities of already existing subscriber devices, one skilled in the art will readily recognize that the frequency ranges available for supporting mobile to mobile communication may be affected by making alterations to the transmission and reception capabilities of existing subscriber devices. A couple of exemplary alterations are discussed below, in connection with the detailed description relative to FIG. 5.

In addition to using the similar pre-designated frequencies used within a cellular communication system, in at least one embodiment, the same or similar wireless transmission protocols are also used. The use of the same or similar transmission protocols serves to further limit the need for modifications of an existing mobile subscriber unit in order to be adapted for use in supporting the herein described system and method for direct mobile to mobile communication.

In yet a still further embodiment, it may further be beneficial to take into account frequency reuse patterns when selecting a particular frequency for use in mobile to mobile communication. For example, it may be beneficial to similarly avoid certain frequencies, that are being avoided by a nearby serving base station. Alternatively, it may be desirable to expressly select one of these frequencies, especially where the same interference concerns, which are present relative to the serving base station are not present in the anticipated mobile to mobile communication.

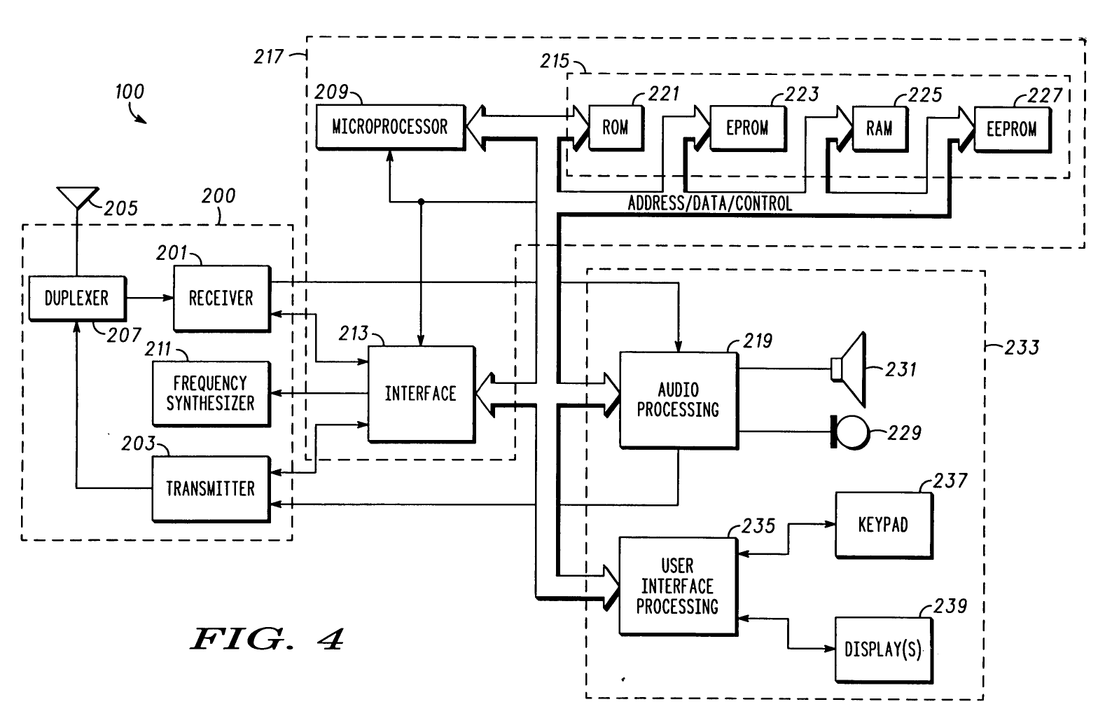

FIG. 4 illustrates a block diagram 100 of a wireless communication device 14, in accordance with at least one embodiment, within which the present invention can be incorporated. The wireless communication device 14 includes an RF interface 200 having a radio receiver 201 and a transmitter 203. Both the receiver 201 and the transmitter 203 are coupled to an antenna 205 of the wireless communication device by way of a duplexer 207. The particular radio frequency to be used by the transmitter 203 and the receiver 201 is determined by the microprocessor 209 and conveyed to the frequency synthesizer 211 via the interface circuitry 213. Data signals received by the receiver 201 are decoded and coupled to the microprocessor 209 by the interface circuitry 213, and data signals to be transmitted by the transmitter 203 are generated by the microprocessor 209 and formatted by the interface circuitry 213 before being transmitted by the transmitter 203. Operational status of the transmitter 203 and the receiver 201 is enabled or disabled by the interface circuitry 213.

In the preferred embodiment, the microprocessor 209 forms part of the processing unit 217, which in conjunction with the interface circuitry 213 performs the necessary processing functions under the control of programs and default sets of parameters stored in a memory section 215. Together, the microprocessor 209 and the interface circuitry 213 can include one or more microprocessors, one or more of which may include a digital signal processor (DSP). The memory section 215 includes one or more forms of volatile and/or non-volatile memory including conventional ROM 221, EPROM 223, RAM 225, and/or EEPROM 227. Characterizing features of the wireless communication device are typically stored in EEPROM 227 (which may also be stored in the microprocessor in an on-board EEPROM, if available) and can include the number assignment module (NAM), which may be required for operation in a conventional cellular system. Alternatively and/or additionally, a subscriber identity module (SIM) or user identity module (UIM) may be used to store user specific information for use by the subscriber unit.

Additionally included in the memory section 215 are prestored instructions for selecting a frequency designated as a mobile communication frequency for use in mobile to mobile communications, transmitting a communication initiation sequence at the selected frequency, monitoring the designated mobile communication frequencies by a second mobile terminal, and detecting the transmission of an initiation sequence. The memory section 215 can additionally include prestored instructions for transmitting an acknowledgement signal in response to detection of an initiation sequence, and/or instructions for determining the geographical region in which the user is presently operating.

Control of the user audio, including the microphone 229 and the speaker 231, is controlled by audio processing circuitry 219, which forms part of a user interface circuit 233. The user interface circuit 233 additionally includes user interface processing circuitry 235, which manages the operation of any keypad(s) 237 and/or display(s) 239. It is further envisioned that any keypad operation could be included as part of a touch sensitive display. The user interface circuit 233 can be used to receive various input stimulus from a user including user actuations, which identify a user selection or a desire to initiate one of various available functions, as well as produce various output stimulus to the user.

FIG. 5 illustrates a more detailed block diagram 150 of at least one possible example of the RF interface 200 and processing control 217 portions of the wireless communication device illustrated in FIG. 4. In the illustrated embodiment, the receiver 201 includes a preselection filter 300 coupled to the duplexer 207. The preselection filter 300 is designed to pass only those frequencies predesignated as receive frequencies. The preselection filter 300 can include a corresponding filter for each of the permissible reception ranges for each of the supported frequency bands of operation. The receiver 201 additionally includes a low noise amplifier/mixer 302, a baseband filter/automatic gain control circuit 304, and analog to digital converters 306.

The low noise amplifier/mixer 302 is coupled to the preselection filter 300, and converts a specific frequency to an intermediate frequency. The specific frequency, which is converted, is determined by an output signal received by the frequency synthesizer 211. The baseband filter/automatic gain control 304, is coupled to the low noise amplifier/mixer 302, for receiving the intermediate frequency signal and further filtering and adjusting the amplitude of the intermediate frequency signal. The amount of adjustment of the amplitude is controlled, at least in part, via a control signal received from the processing unit 217. The filtered and adjusted intermediate frequency signal is then converted from an analog to digital form by the analog to digital convertors 306. The digital form is then forwarded to the processing unit 217 for further processing of the received signal.

The frequency synthesizer 211 includes a reference oscillator 310 for producing a reference signal, which is coupled to a synthesizer/phase lock loop 312. In addition to receiving a reference signal, the synthesizer/phase lock loop 312 is additionally coupled to the processing unit 217 for receiving a control signal, which is used to select the desired frequency of operation. In turn, the synthesizer/phase lock loop 312 produces one or more output signals, which are used by one or more voltage controlled oscillators for producing the signals used by the transmitter 203 and the receiver 201 for selecting the current frequency of operation. In the illustrated embodiment, a separate voltage controlled oscillator 314 and 316 is used for each of the transmitter 203 and the receiver 201.

In the illustrated embodiment, the transmitter 203 includes digital to analog converters 320, which receive a transmit signal encoded in digital form and convert the signal into analog form. The transmitter 203 additionally includes a modulator 322, a transmission bandpass filter 324, and a power amplifier 326. The modulator 322 receives the transmit signal encoded in analog form from the digital to analog converters 320. The transmit signal is then modulated onto a transmit carrier frequency, which is controlled by the output of the transmitter voltage control oscillator 316 of the frequency synthesizer 211. The modulated transmit signal is then filtered by the transmission band pass filter 324 and amplified by the power amplifier 326, and then coupled to the antenna 205, via a duplexer 207 for radiation into space.

While the illustrated embodiment identifies the digital to analog converters 320 and the modulator 322 of the transmitter 203 and the synthesizer/phase lock loop 312 of the frequency synthesizer 211 as separate elements, in one or more alternative embodiments the functionality of the modulator 322 and the digital to analog converters 320 can be included as part of the synthesizer/phase lock loop 312. In FIG. 5, the possible combined functionality is illustrated as area 330 formed from dashed lines, which encapsulate the three elements. In at least one of these alternative embodiments, the synthesizer 330 receives a transmit signal encoded in digital form and directly produces a modulated signal.

As noted previously, by restricting the particular frequencies used for the mobile to mobile communication to pre-designated mobile communication frequencies within a cellular communication system, only minimal modification to a multi-band mobile subscriber unit may be necessary in order to additionally support mobile to mobile communications. Generally most of these changes, in the form of additional programming routines and or control elements, will take place in the processing unit. These changes are further minimized by restricting the frequencies used for mobile to mobile communication to the overlap frequencies, as noted above.

However modifications may be made to the transmitter 203 and the receiver 201 for supporting an enhanced range of frequencies. Generally, the modifications would involve changes to the operational bandwidth of various components. This may involve adjusting the preselection filter 300 and the transmission band pass filter 324 to enable an alternative range of signal frequencies to be blocked and/or filtered. Similarly, the operational range of the voltage controlled oscillators 314 and 316 may need to be expanded and/or adjusted. In this way an even greater range of frequencies supporting both transmission and reception may be available for use in a mobile to mobile communication.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

1. A method for establishing direct mobile to mobile communication between cellular mobile terminals, said method comprising:
selecting a frequency designated as a mobile communication frequency within a cellular communication system;
transmitting by a first mobile terminal a communication initiation sequence at the selected frequency;
monitoring by a second mobile terminal the designated mobile communication frequencies; and
detecting by the second mobile terminal the communication initiation sequence.

2. The method in accordance with claim 1 wherein prior to transmitting by a first mobile terminal a communication initiation sequence at the selected frequency, a user actuation is received.

3. The method in accordance with claim 1 wherein selecting a frequency includes determining the region in which the first mobile terminal is operating, and selecting a mobile communication frequency for the determined region.

4. The method in accordance with claim 3 wherein the mobile communication frequency is a mobile transmission frequency for the determined region.

5. The method in accordance with claim 3 wherein the mobile communication frequency is a mobile reception frequency for the determined region.

6. The method in accordance with claim 3 wherein determining the region in which the first mobile terminal is operating includes receiving an operating region selection from a user.

7. The method in accordance with claim 3 wherein determining the region in which the first mobile terminal is operating includes receiving one or more global positioning system signals.

8. The method in accordance with claim 3 wherein determining the region in which the first mobile terminal is operating includes maintaining a record of the last region in which the first mobile terminal successfully operated.

9. The method in accordance with claim 1 wherein selecting a frequency includes selecting a frequency that is designated as a mobile transmit frequency in a first supported region and is designated as a mobile receive frequency in a second supported region.

10. The method in accordance with claim 9 wherein the first supported region is the region in which the first mobile terminal is operating

11. The method in accordance with claim 1 wherein the communication initiation sequence includes frequency and timing information for use in the remainder of the communication between the mobile terminals.

12. The method in accordance with claim 1 further comprising prior to selecting a frequency and further establishing the direct mobile to mobile communication, scanning for existing network coverage by the first mobile terminal, wherein direct mobile to mobile communication is authorized in areas where at least one of network coverage is insufficient or where authorization for direct mobile to mobile communication is obtained from the network.

13. The method in accordance with claim 12 wherein, when authorization is obtained from the network, the frequency selected corresponds to any frequency designation supplied by the network.

14. The method in accordance with claim 1 further comprising, after selecting a frequency, selecting a channel associated with the selected frequency after monitoring the channel to insure the channel is not being currently used.

15. The method in accordance with claim 1 wherein the initiation sequence is transmitted for a period of time having a duration that overlaps at least a portion of the wake-up period of the second mobile terminal.

16. The method in accordance with claim 1 wherein after detecting the communication initiation sequence by the second mobile terminal, the second mobile terminal transmits an acknowledgement signal, in response to a detected communication initiation sequence.

17. The method in accordance with claim 16 wherein the acknowledgement signal includes receiver quality data.

18. The method in accordance with claim 17 wherein the receiver quality data includes receiver level information.

19. The method in accordance with claim 16 wherein the acknowledgement signal is transmitted by the second mobile terminal at the selected frequency at alternative times relative to the transmissions from the first mobile terminal at the selected frequency.

20. The method in accordance with claim 19 wherein the alternative times that the second mobile terminal transmits a signal at the selected frequency has a predetermined time offset relative to any corresponding adjacent transmission from the first mobile terminal.

21. The method in accordance with claim 19 wherein the transmissions from each of the first and second mobile terminals at the selected frequency are part of a time division duplex channel.

22. The method in accordance with claim 1 wherein the cellular mobile terminals including the first mobile terminal and the second mobile terminal are multi-region devices.

23. A cellular mobile terminal adapted for direct mobile to mobile communication, said mobile terminal comprising:
a transmitter;
a receiver; and
a control circuit, coupled to the transmitter and the receiver,
wherein at least one of the transmitter and the receiver is adapted to function at a frequency of operation, corresponding to the other one of the transmitter and the receiver.

24. A cellular mobile terminal in accordance with claim 23 wherein the receiver includes a preselection filter, which is adapted to pass frequencies including transmitter frequencies of operation of the mobile terminal.

25. A cellular mobile terminal in accordance with claim 23 wherein the receiver includes a voltage controlled oscillator having an operational range that is extended to include transmitter frequencies of operation of the mobile terminal.

26. A cellular mobile terminal in accordance with claim 23 wherein the transmitter includes a transmission bandpass filter, which is adapted to pass frequencies including receiver frequencies of operation of the mobile terminal.

27. A cellular mobile terminal in accordance with claim 23 wherein the transmitter includes a voltage controlled oscillator having an operational range that is extended to include receiver frequencies of operation of the mobile terminal.

28. A cellular mobile terminal in accordance with claim 23 wherein the control circuit includes a user actuated switch adapted to initiate a mobile to mobile communication.
